(19) United States
(12) Patent Application Publication
(10) Pub. No.: US 2014/0314250 A1
(43) Pub. Date: Oct. 23, 2014

(54) POSITION ESTIMATION SYSTEM USING AN AUDIO-EMBEDDED TIME-SYNCHRONIZATION SIGNAL AND POSITION ESTIMATION METHOD USING THE SYSTEM

(71) Applicant: Electronics and Telecommunications Research Institute, Daejeon-si (KR)

(72) Inventors: Tae Jin PARK, Seoul (KR); Jeong Il SEO, Daejeon (KR); Dae Young JANG, Daejeon (KR); Kyeong Ok KANG, Daejeon (KR); Jin Woong KIM, Daejeon (KR)

(73) Assignee: Electronics and Telecommunications Research Institute, Daejeon-si (KR)

(21) Appl. No.: 13/961,993

(22) Filed: Aug. 8, 2013

(30) Foreign Application Priority Data
Apr. 22, 2013 (KR) 10-2013-0043955

(51) Int. Cl. G01S 3/801

(52) U.S. Cl. CPC G01S 3/801
USPC 381/92

(57) ABSTRACT

Disclosed is a method of estimating a position by a position estimation system. The method includes generating a time-synchronization signal for position determination using a genetic algorithm, embedding the generated time-synchronization signal in an audio signal, and replaying the audio signal embedded with the time-synchronization signal through a speaker, receiving the audio signal embedded with the time-synchronization signal in a microphone, calculating a time delay value of the time-synchronization signal embedded in the received audio signal, and estimating a position of the microphone based on the calculated time delay value.

Priority to Korean patent application number 10-2013-0043955 filed on Apr. 22, 2013, the entire disclosure of which is incorporated by reference herein, is claimed.

### BACKGROUND OF THE INVENTION

1. Field of the Invention

The present invention relates to a system for estimating a position using a time-synchronization signal, and a method of estimating a position using the system.

2. Discussion of the Related Art

Indoor navigation systems in a prior art have estimated a position by receiving electromagnetic waves transmitted from a plurality of positions through a sensor as in a global positioning system (GPS).

For example, according to Korean Patent Application Publication No. 10-2012-0049600 (Published on May 17, 2012) “Short range location tracking system and method using wireless network”, if a plurality of radio frequency (RF) transmitting/receiving terminals receive an RF signal transmitted from an RF sending terminal attached or carried on each moving object, one RF transmitting/receiving terminal receives a level value of the RF signal and location information of the RF transmitting/receiving terminal from two or more RF transmitting/receiving terminals except the one RF transmitting/receiving terminal, and calculates and traces the location of the moving object using trigonometry based on the location coordinates of the three RF transmitting/receiving terminals.

However, in such a prior location tracking method, a device for artificially generating signals at a certain location needs to be additionally installed for location determination as in a beacon, and thus a lot of costs are required in building a system, long time is needed for estimating the position, and a significant distance error may be generated.

Hence, there is a need for a position estimation method capable of reducing costs required in building a system, quickly estimating the position, and precisely estimating the position.

### SUMMARY OF THE INVENTION

An object of the present invention is to provide a position estimation system using an audio-embedded time-synchronization signal and a position estimation method using the system, which may prevent of recognition by human ears by embedding the time-synchronization signal for position determination in a high tone range frequency of an audio signal, and may reduce costs required when building a position estimation system by sensing the position of a microphone by receiving the embedded time-synchronization signal in the microphone.

Another object of the present invention is to provide a position estimation system using an audio-embedded time-synchronization signal and a position estimation method using the system, which may quickly estimate a position compared to the existing position estimation system.

Another object of the present invention is to provide a position estimation system using an audio-embedded time-synchronization signal and a position estimation method using the system, which may accurately estimate a position compared to the existing position estimation system.

In accordance with an aspect of the present invention, a method of estimating a position by a position estimation system includes generating a time-synchronization signal for position determination using a genetic algorithm, embedding the generated time-synchronization signal in an audio signal, and replaying the audio signal embedded with the time-synchronization signal through a speaker, receiving the audio signal embedded with the time-synchronization signal in a microphone, calculating a time delay value of the time-synchronization signal embedded in the received audio signal, and estimating a position of the microphone based on the calculated time delay value.

The generating may include generating the time-synchronization signal for each channel of the speaker using the genetic algorithm.

The time-synchronization signal generated for each channel may use sub-carriers which are not overlapped with each other in each frequency domain.

The generating may include arranging the sub-carriers in a chromosome array in the genetic algorithm so that an auto-correlation signal of each time-synchronization signal may have a maximum peak to side peak ratio (PSPR) value, and generating a time-synchronization signal for a channel of the speaker using information of the chromosome arrays in which the sub-carriers are arranged.

The replaying may include embedding the generated time-synchronization signal in a predetermined high-frequency domain of a frequency domain of the audio signal and replaying the embedded time-synchronization signal.

The replaying may include converting the generated time-synchronization signal into a signal having a size except a phase in the frequency domain of the audio signal using a discrete Fourier transform (DFT), and embedding the converted time-synchronization signal in the audio signal, and replaying the audio signal embedded with the time-synchronization signal through the speaker.

The calculating may include separating the received audio signals by frequencies, and calculating the time delay value by analyzing the audio signals separated by frequencies.

The estimating may include estimating the position of the microphone by calculating a distance between the speaker and the microphone based on the calculated time delay value.

After the estimating, the method may further include adjusting a forwarding direction of sound waves based on the estimated position of the microphone.

In accordance with another aspect of the present invention, a replay device includes a generation unit that generates a time-synchronization signal for position determination using a genetic algorithm, a replay unit that embeds the generated time-synchronization signal in an audio signal, and replays the audio signal embedded with the time-synchronization signal through a speaker, and adjustment unit that adjusts a direction of sound waves based on a position of a sound-receiving device that has received the replayed audio signal, wherein the position of the sound-receiving device is estimated based on a time delay value of the time-synchronization signal.

In accordance with another aspect of the present invention, a sound-receiving device includes a sound-receiving unit that receives an audio signal embedded with a time-synchronization signal for position determination in a microphone, and a calculation unit that calculates a time delay value of the time-synchronization signal embedded in the received the audio signal, wherein the time-synchronization signal is generated based on a genetic algorithm by a replay device that replays the audio signal.

### BRIEF DESCRIPTION OF THE DRAWINGS

FIG. 1 is a flowchart illustrating a method of estimating a position using an audio-embedded time-synchronization signal, according to an embodiment of the present invention;

FIG. 2 is a diagram illustrating a method of estimating a distance of a time of arrival (TOA) scheme, according to an embodiment of the present invention;

FIGS. 3 and 4 are diagrams illustrating a process of generating an optimized time-synchronization signal, according to an embodiment of the present invention;

FIGS. 5 and 6 are diagrams illustrating a process of audio-embedding a time-synchronization signal, according to an embodiment of the present invention; and

FIG. 7 is a block diagram illustrating a system for estimating a position using an audio-embedded time-synchronization signal, according to an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

The objects and effects of the present invention can be naturally understood or become clear by the following description, and the objects and effects of the present invention are not restricted by the following description only.

The objects, characteristics, and merits will become more apparent from the following detailed description. Furthermore, in describing the present invention, a detailed description of a known art related to the present invention will be omitted if it is deemed to make the gist of the present invention unnecessarily vague. A preferred embodiment in accordance with the present invention is described in detail below with reference to the accompanying drawings.

The term “include” in the present specification does not exclude other components which are not described here unless specifically disclosed otherwise, and may further include other components. Furthermore, the term “ . . . unit” refers to a unit for processing at least one function or operation, and may be implemented by hardware, software or a combination thereof.

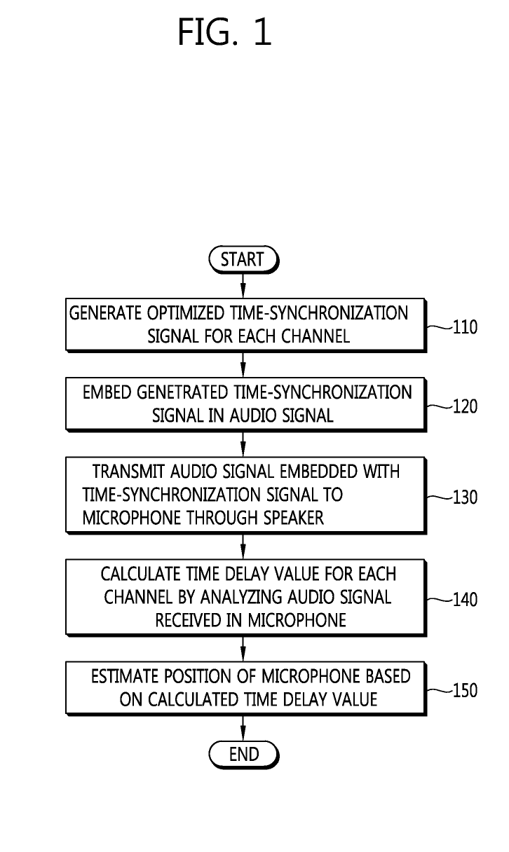

FIG. 1 is a flowchart illustrating a method of estimating a position using an audio-embedded time-synchronization signal, according to an embodiment of the present invention. Hereinafter, a method of estimating a position of a microphone using a time-synchronization signal by a position estimation system according to the present invention will be described with reference to FIG. 1.

The position estimation system according to the present invention may transmit signals needed for position estimation to a microphone through a loud speaker using sound waves as a medium. To this end, the position estimation system according to the present invention may transmit the audio-embedded time-synchronization signals in a high tone range of several kHz or more and through a loud speaker of a general audio system by applying a time-synchronization scheme that uses a pilot sub-carrier used in an orthogonal frequency division multiplexing (OFDM) communication method to an audio system. Furthermore, a distance between the speaker and the microphone may be estimated using a time delay value of the time-synchronization signal, and through which the position of the microphone or a device including the microphone may be recognized.

Specifically, the position estimation system according to the present invention generates a time-synchronization signal for position determination using a genetic algorithm. At this time, as illustrated in FIG. 1, the position estimation system may generate an optimized time synchronization signal for each channel of the speaker using the genetic algorithm (110). Here, the speaker may be a multi-channel (2.1 ch, 5.1 ch, 7.1 ch, 10.2 ch, 22.2 ch, etc.) loud speaker, and the time-synchronization signal generated for each channel of the multi-channel loud speaker may use a sub-carrier which is not overlapped with each other in each frequency domain.

To this end, the position estimation system according to the present invention may arrange the sub-carrier so that an auto-correlation function of each time synchronization signal may have the maximum peak to side peak ratio (PSPR) in the chromosome array within the genetic algorithm, and generate the time-synchronization signal using information of the chromosome arrays in which the sub-carriers are arranged.

If the time-synchronization signal is generated, the position estimation system according to the present invention may respectively embed each time-synchronization signal in the audio signal replayed through each channel of the speaker (120), and replay the audio signal embedded with the time-synchronization signal so that the time-synchronization signal may be transmitted to the microphone (130). At this time, the position estimation system according to the present invention may embed the time-synchronization signal in a predetermined high frequency domain of a frequency domain of the audio signal and replay the embedded time-synchronization signal.

For an example, the position estimation system according to the present invention may convert a time-synchronization signal into a signal having a size except a phase in the frequency domain of the audio signal using a Discrete Fourier Transform (DFT) and embed the converted signal in the audio signal, and may replay the audio signal embedded with the time-synchronization signal through a speaker.

If the audio signal embedded with the time-synchronization signal is replayed, the position estimation system according to the present invention may calculate the time delay value of the time-synchronization signal embedded in the channel (140) by analyzing the audio signal received in the microphone, and may then estimate the position of the microphone based on the calculated time delay value (150).

For example, the position estimation system according to the present invention may divide received audio signals by frequencies and analyze the divided audio signals using a cross-correlation function so as to calculate a time delay value. If the time delay value of the time-synchronization signal is calculated through such a process, the position estimation system according to the present invention may estimate the position of the microphone by calculating a distance between the speaker and the microphone based on the calculated time delay value.

Thereafter, the position estimation system according to the present invention may replay stereophonic sounds depending on the position of the microphone by adjusting a forwarding direction of sound waves based on the estimated position of the microphone, or may generate a personalized sound zone where sound energy is concentrated based on the position of a user.

The position estimation system according to the present invention may be used to a service that needs recognition of a position of the user having a device (a smart phone, a tablet computer, etc.) including a mono microphone in a place where a loud speaker is installed.

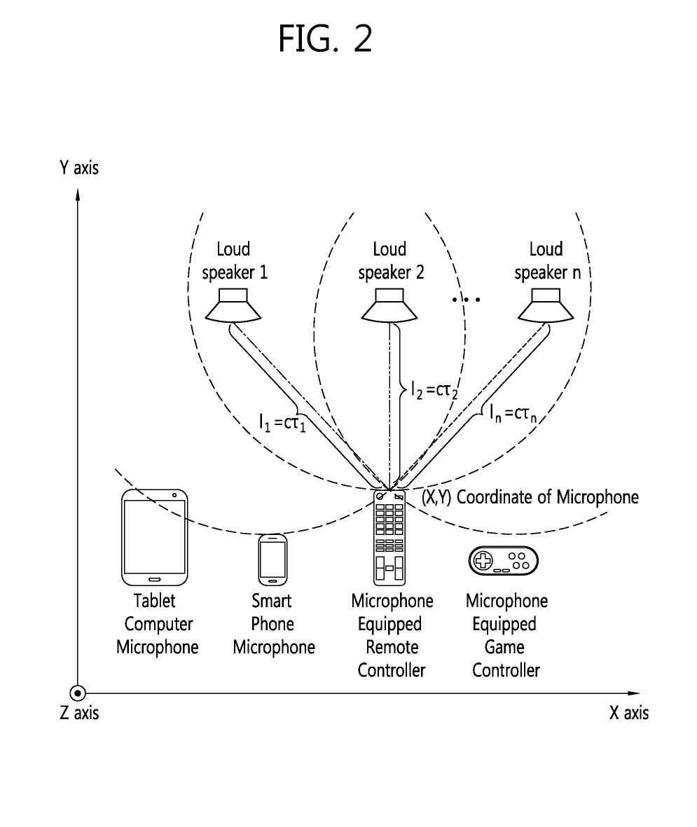

FIG. 2 is a diagram illustrating a method of estimating a distance of a time of arrival (TOA) scheme, according to an embodiment of the present invention. Hereinafter, a process of estimating a position of a microphone by a position estimation system according to the present invention will be described in detail with reference to FIG. 2.

The position estimation system according to the present invention may estimate the position of the microphone using a method of estimating a distance based on time of arrival (TOA) of a signal. Specifically, the position estimation system according to the present invention may receive time-synchronization signals outputted from each channel (Loud speaker 1, Loud speaker 2, and Loud speaker n) in the microphone, and may then calculate the time delay of each time-synchronization signal to calculate the distance between the microphone and the loud speaker as illustrated in FIG. 2. In FIG. 2, a distance (l) from the microphone to each loud speaker is the product (l=cτ) of speed (c) of sound and a time delay value (τ).

When a replay device for replaying audio signals and a sound-receiving device for receiving audio signals share a clock through a wire or wireless connection, the position estimation system according to the present invention may estimate the position with only two channels. However, when the clock is not shared, the position may be estimated by receiving signals from three or more channels. For example, if the loud speaker is arranged on an XY plane as illustrated in FIG. 1, the position estimation system according to the present invention may estimate the position on the xy coordinates such as a smart phone, a tablet PC, a remote controller and a game controller having a microphone.

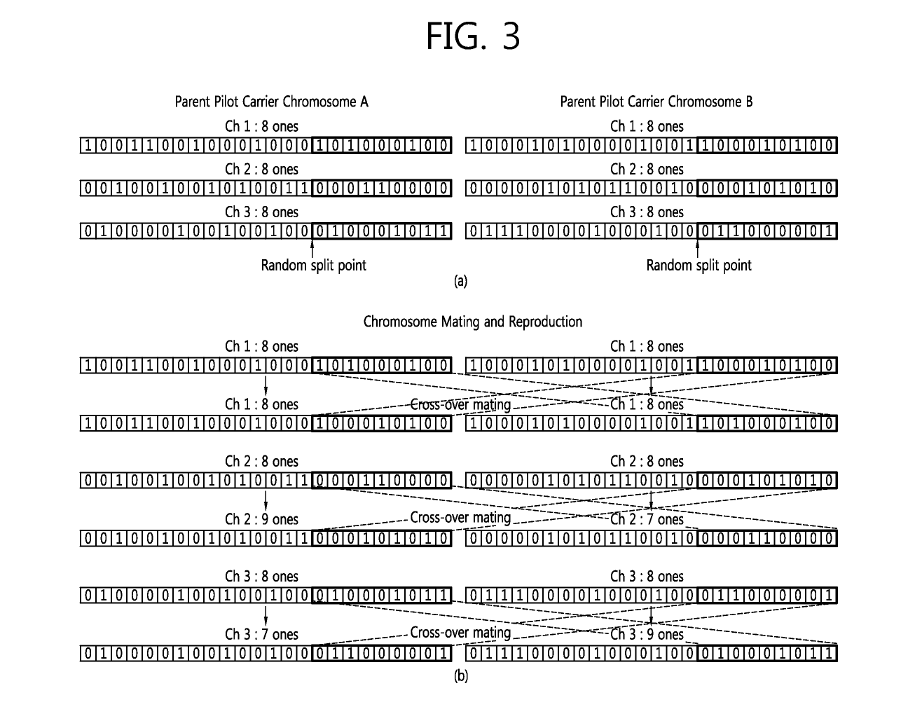

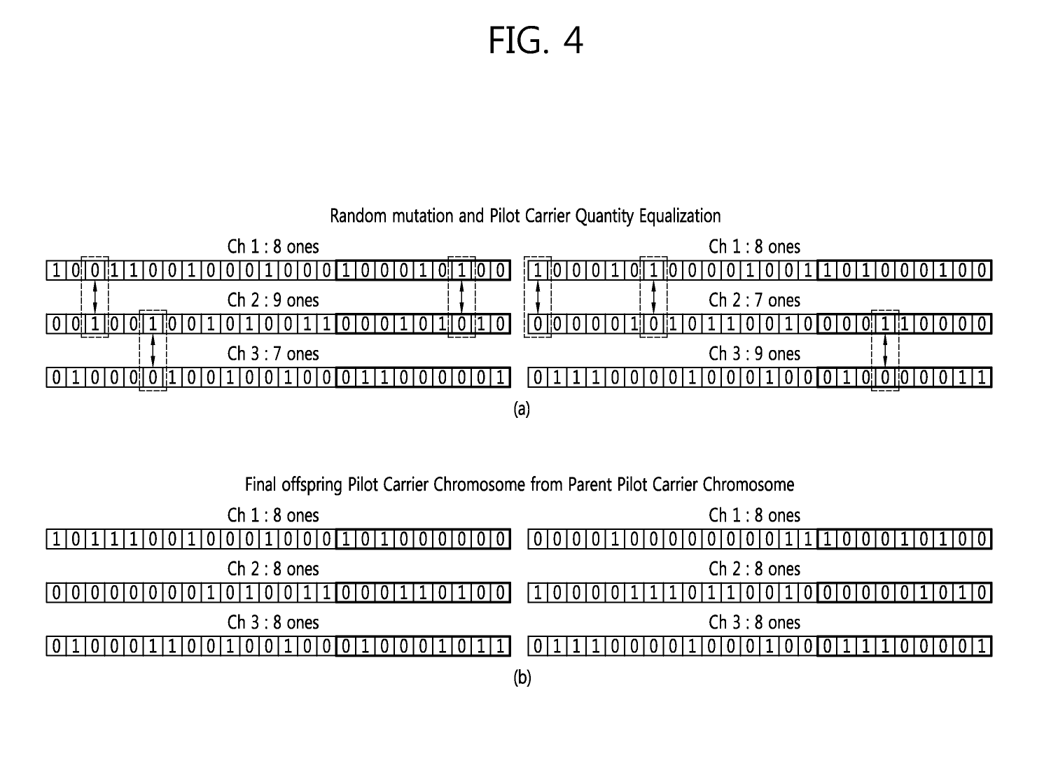

FIGS. 3 and 4 are diagrams illustrating a process of generating an optimized time-synchronization signal, according to an embodiment of the present invention.

When generating a time-synchronization signal to be embedded in an audio signal, attributes of the time-synchronization signal are important. In order to effectively distinguish time-synchronization signals replayed in two or more channels using only the mono microphone mounted on a general smart phone or tablet computer, the time synchronization signal should satisfy the following two conditions.

a. The signals of respective loud speaker channels need to use different sub-carriers which are not overlapped with each other in the frequency domain to prevent mutual interference.

b. The auto-correlation function of the time-synchronization signal of each channel needs to have the maximum peak to sidepeak ratio (PSPR).

The auto-correlation function of the time-synchronization signal has Equation 1 described below.

$$R ( τ ) = {\sum }_{n = 0}^{N - 1} s ( n ) s ( n + τ ) \\ PSPR = \frac{R ( 0 )}{{max}_{τ \neq 0} \vert R ( τ ) \vert} \qquad Equation 1$$

Here, s(n) represents a time-synchronization signal, and R(τ) represents an auto-correlation function. The PSPR value of the auto-correlation function is determined according to the arrangement of the sub-carrier. The signal having a large PSPR value of the auto-correlation function is strong to noise signals, and the probability of interference with another channel signal is also reduced.

The arrangement of sub-carriers for each channel for satisfying both conditions a and b cannot obtain a solution in a general equation form, and thus an optimization process may be performed to be arranged so that each channel has an independent sub-carrier and the auto-correlation function of the time-synchronization signal for each channel has the maximum PSPR value using the genetic algorithm.

The position estimation system according to the present invention generates a time-synchronization signal using the genetic algorithm that repeats crossing of a chromosome, natural selection, order arrangement, and re-crossing. Here, the position estimation system according to the present invention may go through the process of optimizing the position of the sub-carrier in the chromosome array within the genetic algorithm in order to generate the time-synchronization signal having the optimal attributes in two or more independent channels.

The number of channels of the loud speaker used in the position estimation system according to the present invention may be between the maximum number 2 and an arbitrary number N. However, it is assumed here that the number of channels of the loud speaker is 3 for the convenience of description.

FIGS. 3 and 4 illustrate a crossing and mutation processes between chromosomes in a genetic algorithm including three channels and two gene pools. In FIGS. 3 and 4, each box of the chromosome array denotes the frequency, “1” indicates that there are sub-carriers in the frequency, and “0” indicates that there is no sub-carrier in the frequency.

The chromosome array from the parent chromosome of the previous step has the same number (8) of sub-carriers as illustrated in FIG. 3A. Here, chromosome arrays A and B denote one gene pool, respectively.

The position estimation system arbitrarily divides each chromosome array into chromosomes in the same channel and then recombines the divided chromosomes as illustrated in FIG. 3B.

Thereafter, the chromosome array is randomly mutated so that each channel has the same number of sub-carriers, and thereby the numbers of the sub-carriers of the recombined chromosome array becomes uniform as illustrated in FIG. 4A.

The completed chromosome arrays of the next generation go through a process of selection and failure in a decreasing order of the PSPR value mentioned in equation 1 as illustrated in FIG. 4B. The position estimation system repeats the process of crossing and mutation for only the survived chromosome array. Furthermore, a time-synchronization signal is generated using information of the chromosome arrays that have gone through the above process, as shown in Equation 2 below.

$${U}_{Ch 1} ( n ) = {\sum }_{k ∈ Ch 1}^{ } sin ( {ω}_{k} n + {Θ}_{ch 1} ) \\ {U}_{Ch 2} ( n ) = {\sum }_{k ∈ Ch 2}^{ } sin ( {ω}_{k} n + {Θ}_{ch 2} ) \\ {U}_{Ch 3} ( n ) = {\sum }_{k ∈ Ch 3}^{ } sin ( {ω}_{k} n + {Θ}_{ch 3} ) \qquad Equation 2$$

In Equation 2 above, Ch1, Ch2, and Ch3 respectively represent a frequency set of sub-carriers of an optimized chromosome array for each channel, and U_{Ch1}(n), U_{Ch2}, and U_{Ch3}(n) denote a time-synchronization signal in the time domain for each channel. N denotes the entire length of the time-synchronization signal, ωₖ denotes angular velocity of each frequency, and Θ_{ch1}, Θ_{ch2}, and Θ_{ch3} denote the phase corresponding to each channel. Here, the phase value has been randomly selected because the phase value does not affect the auto-correlation function having PSPR value for the time-synchronization signal.

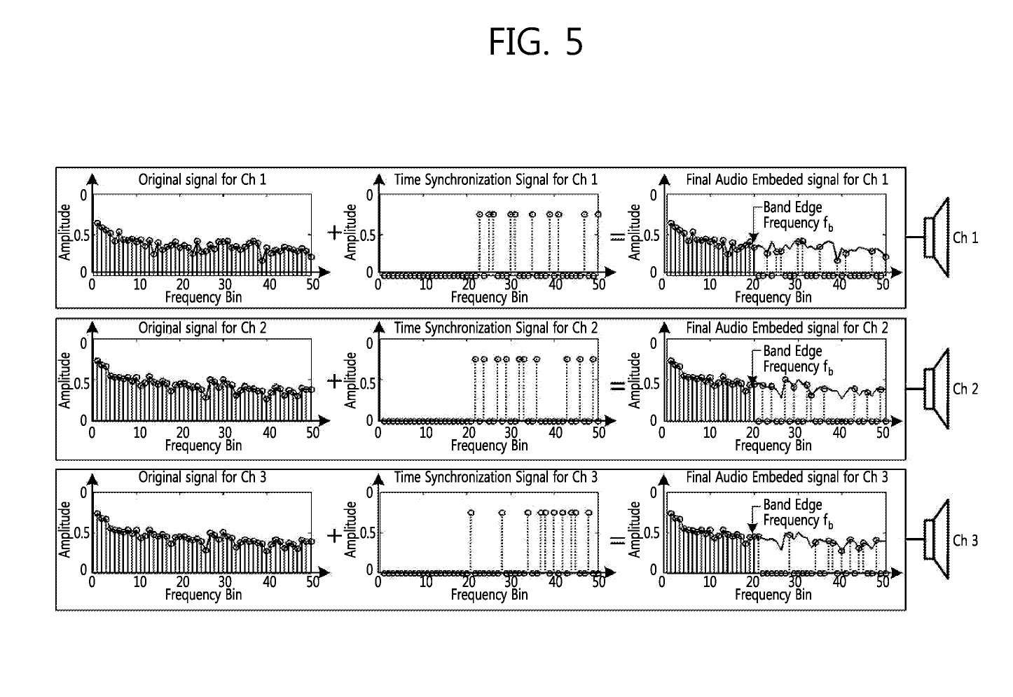

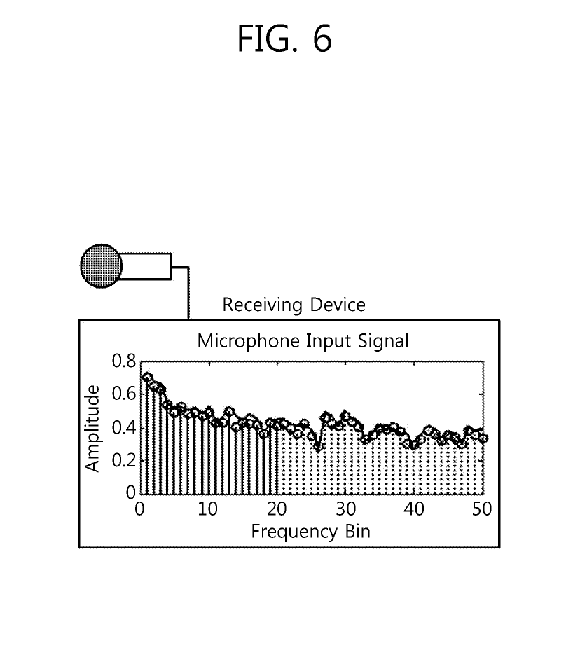

FIGS. 5 and 6 are diagrams illustrating a process of audio-embedding a time-synchronization signal, according to an embodiment of the present invention.

The time-synchronization signal optimized through the genetic algorithm may be converted into the frequency domain through the Discrete Fourier Transform (DFT). The time-synchronization signal converted into the frequency domain has components of each frequency not overlapped with each other as shown in Equation 3 below.

$${\sum }_{k = 0}^{N - 1} {\sum }_{r = 1}^{CN} {U}_{r} ( k ) = 0 \qquad Equation 3$$

Here, CN denotes the number of all channels, and N denotes the entire length of the time-synchronization signal.

The time-synchronization signal converted into the frequency domain may be converted into a signal having a size except the phase in the frequency domain of the original audio signal in more than a certain threshold frequency f_{b} of more than some kHz as shown in FIG. 5. This is to hide (embed) the time-synchronization signal so that the time-synchronization is not heard to the listener.

The audio signal embedded with the time-synchronization signal is transmitted from a loud speaker to a microphone through the air, and is transmitted to a sound-receiving device through the microphone. FIG. 6 illustrates an audio signal that has been transmitted to a microphone, as an example.

The sound-receiving device that receives the audio signal embedded with the time-synchronization signal may calculate the arrival time delay τ of each channel through a cross-correlation function, as shown in Equation 4 below.

$${τ}_{ch} = {arg }_{τ} max ( {\sum }_{n = 0}^{N - 1} {U}_{mic , ch} ( n ) {U}_{ch} ( n + τ ) ) \qquad Equation 4$$

Here, U_{mic,ch}(n) denotes a reception signal separated by only the sub-carrier frequency corresponding to the channel among the signals received in the microphone, and U_{ch}(n) denotes the original time-synchronization signal of the channel that is generated through the genetic algorithm.

As such, the position estimation system may receive the time-synchronization signal in the microphone and calculate the position while listening to sounds when the user uses a general loud speaker.

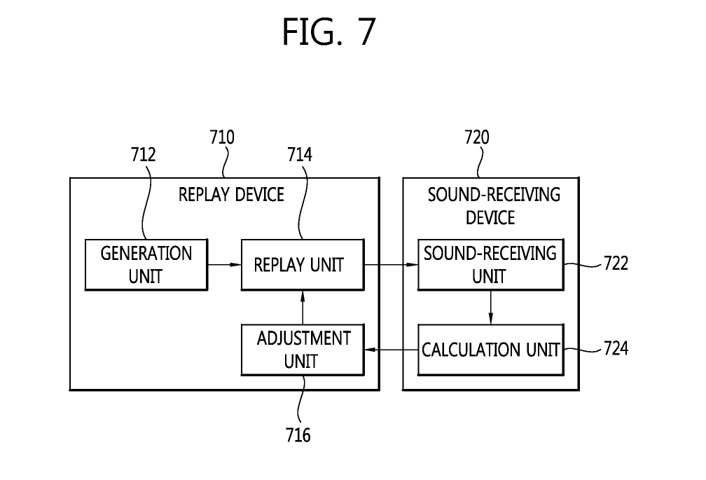

FIG. 7 is a block diagram illustrating a system for estimating a position using an audio-embedded time-synchronization signal, according to an embodiment of the present invention.

The position estimation system according to the present invention includes a replay device 710 that replays an audio signal embedded with the time-synchronization signal, and a sound-receiving device 720 that receives signals replayed by the replay device 710, as illustrated in FIG. 7.

First of all, the replay device 710 may include a generation unit 712, a replay unit 714, and an adjustment unit 716.

The generation unit 712 generates a time-synchronization signal for position determination using the genetic algorithm. Here, the generation unit 712 may generate the time-synchronization signal for each channel of the speaker using the sub-carriers which are not overlapped with each other in each frequency domain based on the genetic algorithm. For an example, the generation unit 712 may arrange the sub-carriers in the chromosome array within the genetic algorithm so that the auto-correlation function of each time-synchronization signal has the maximum peak to side peak ratio (PSPR), and may generate the time-synchronization signal for each channel of the speaker using information of the chromosome arrays in which the sub-carriers are arranged. Here, if the generation unit shares the clock with the sound-receiving device, the generation unit may generate the time-synchronization signal for two channels.

The replay unit 714 embeds the time-synchronization signal generated in the generation unit 712 in the audio signal, and replays the audio signal embedded with the time-synchronization signal using the speaker. At this time, the replay unit 714 may embed the time-synchronization signal generated in the generation unit 712 in the predetermined high frequency domain of the frequency domain of the audio signal and replay the embedded time-synchronization signal so that the time-synchronization signal is not heard by human ears.

For an example, the replay unit 714 may convert the time-synchronization signal into a signal having a size except the phase in the frequency domain of the audio signal using a discrete Fourier transform (DFT), and embed the time-synchronization signal in the audio signal.

The adjustment unit 716 adjusts a direction of sound waves based on the position of the sound-receiving device that receives the audio signals replayed in the replay unit 714. Here, the position of the sound-receiving device may be estimated based on the time delay value of the time-synchronization signal, and the time delay value of the synchronization signal may be calculated by being separated for each frequency by the sound-receiving device and being analyzed through the cross-correlation function.

For an example, the adjustment unit 716 may adjust the direction of sound waves by calculating the distance between the speaker and the sound-receiving device based on the time delay value received from the sound-receiving device, or may adjust the direction of the sound waves by receiving information on the distance between the speaker and the sound-receiving device which is calculated based on the time delay value from the sound-receiving device.

Meanwhile, the sound-receiving device 720 may include a sound-receiving unit 722 and a calculation unit 724.

The sound-receiving unit 722 receives the audio signal which is replayed from the replay unit 710 and embedded with the time-synchronization signal in the microphone. The time-synchronization signal embedded in the audio signal may be generated based on the genetic algorithm, and may be generated based on information of chromosome arrays where the sub-carriers not overlapped with each other are arranged in each frequency domain so that the auto-correlation function of the time-synchronization signal generated for each channel has the maximum peak to side peak ratio (PSPR) value. For example, the time-synchronization signal may be converted into a signal having a size except the phase in the frequency domain of the audio signal through the discrete Fourier transform (DFT) so that the time-synchronization signal may be embedded in the predetermined high frequency domain of the frequency domain of the audio signal.

The calculation unit 724 calculates the time delay value of the time-synchronization signal embedded in the audio signal received through the sound-receiving unit 722. Thereafter, the calculation unit 724 may transmit the calculated time delay value to the replay device 701 or calculate the distance between the speaker and the microphone and then transmit information on the calculated distance to the replay device 710 so that the replay device 710 may adjust the direction of sound waves based on the information on the calculated distance.

Unlike the existing position estimation methods of attaching beacons that transmit supersonic waves, electromagnetic waves, or infrared rays, and estimating a position by receiving signals of the beacons, in the present invention, the position is estimated by using only the signals from a speaker which is already installed in the audio system, and a microphone, and thus the position may be estimated by adding only the mono microphone to the existing audio system. Furthermore, even such a mono microphone may be substituted by a smart phone or a tablet PC of a user. Hence, it is possible to build the system with low costs.

It takes a short time in receiving audio signals needed in estimating the position, and thus the position may be quickly estimated.

Since high frequency waves are used, the distance error is small, and since the orthogonal frequencies of the OFDM are used, it is possible to accurately estimate the position even in a place closer to the speaker than the existing method.

A person having ordinary skill in the art to which the present invention pertains may change and modify the present invention in various ways without departing from the technical spirit of the present invention. Accordingly, the present invention is not limited to the above-described embodiments and the accompanying drawings.

What is claimed is:

1. A method of estimating a position by a position estimation system, the method comprising:
generating a time-synchronization signal for position determination using a genetic algorithm;
embedding the generated time-synchronization signal in an audio signal, and replaying the audio signal embedded with the time-synchronization signal through a speaker;
receiving the audio signal embedded with the time-synchronization signal in a microphone;
calculating a time delay value of the time-synchronization signal embedded in the received audio signal; and
estimating a position of the microphone based on the calculated time delay value.

2. The method of claim 1, wherein the generating comprises generating the time-synchronization signal for each channel of the speaker using the genetic algorithm.

3. The method of claim 2, wherein the time-synchronization signal generated for each channel uses sub-carriers which are not overlapped with each other in each frequency domain.

4. The method of claim 2, wherein the generating comprises:
arranging the sub-carriers in a chromosome array in the genetic algorithm so that an auto-correlation function of each time-synchronization signal may have a maximum peak to side peak ratio (PSPR) value; and
generating a time-synchronization signal for a channel of the speaker using information of the chromosome arrays in which the sub-carriers are arranged.

5. The method of claim 1, wherein the replaying comprises embedding the generated time-synchronization signal in a predetermined high-frequency domain of the frequency domain of the audio signal and replaying the embedded time-synchronization signal.

6. The method of claim 1, wherein the replaying comprises:
converting the generated time-synchronization signal into a signal having a size except a phase in the frequency domain of the audio signal using a discrete Fourier transform (DFT), and embedding the converted time-synchronization signal in the audio signal; and
replaying the audio signal embedded with the time-synchronization signal through the speaker.

7. The method of claim 1, wherein the calculating comprises:
separating the received audio signals by frequencies; and
calculating the time delay value by analyzing the audio signals separated by frequencies.

8. The method of claim 1, wherein the estimating comprises estimating the position of the microphone by calculating a distance between the speaker and the microphone based on the calculated time delay value.

9. The method of claim 1, after the estimating, further comprising:
adjusting a forwarding direction of sound waves based on the estimated position of the microphone.

10. A replay device comprising:
a generation unit that generates a time-synchronization signal for position determination using a genetic algorithm;
a replay unit that embeds the generated time-synchronization signal in an audio signal, and replays the audio signal embedded with the time-synchronization signal through a speaker; and
adjustment unit that adjusts a direction of sound waves based on a position of a sound-receiving device that has received the replayed audio signal,
wherein the position of the sound-receiving device is estimated based on a time delay value of the time-synchronization signal.

11. The replay device of claim 10, wherein the generation unit generates the time-synchronization signal for each channel of the speaker using sub-carriers which are not overlapped with each other in each frequency domain based on the genetic algorithm.

12. The replay device of claim 11, wherein the generation unit arranges the sub-carriers in a chromosome array in the genetic algorithm so that an auto-correlation signal of each time-synchronization signal may have a maximum peak to side peak ratio (PSPR) value, and generates a time-synchronization signal for a channel of the speaker using information of the chromosome arrays in which the sub-carriers are arranged.

13. The replay device of claim 10, wherein the generation unit generates a time-synchronization signal for two channels if the generation shares a clock with the sound-receiving device.

14. The replay device of claim 10, wherein the replay unit embeds the generated time-synchronization signal in a predetermined high-frequency domain of the frequency domain of the audio signal and replaying the embedded time-synchronization signal so that the generated time-synchronization signal is not heard by human ears.

15. The replay device of claim 10, wherein the replay unit converts the generated time-synchronization signal into a signal having a size except a phase in the frequency domain of the audio signal using a discrete Fourier transform (DFT), and embeds the converted time-synchronization signal in the audio signal.

16. The replay device of claim 10, wherein the time delay value is calculated by being separated for each frequency by the sound-receiving device and being analyzed through a cross-correlation function.

17. The replay device of claim 10, wherein the adjustment unit adjusts the direction of the sound waves by calculating a distance between the speaker and the sound-receiving device based on the time delay value received from the sound-receiving device, or adjusts the direction of the sound waves by receiving from the sound-receiving device information on the distance between the speaker and the sound-receiving device calculated based on the time delay value.

18. A sound-receiving device comprising:
a sound-receiving unit that receives an audio signal embedded with a time-synchronization signal for position determination in a microphone; and
a calculation unit that calculates a time delay value of the time-synchronization signal embedded in the received the audio signal,
wherein the time-synchronization signal is generated based on a genetic algorithm by a replay device that replays the audio signal.

19. The sound-receiving device of claim 18, wherein the time-synchronization signal is generated based on information on chromosome arrays in which sub-carriers not overlapped with each other in each frequency domain are arranged so that an auto-correlation function of the time-synchronization signal generated for each channel has a maximum peak to side peak ratio (PSPR) value.

20. The sound-receiving device of claim 18, wherein the time-synchronization signal is converted into a signal having a size except a phase in the frequency domain of the audio signal using a discrete Fourier transform (DFT), and is embedded in a predetermined high-frequency domain of a frequency domain of the audio signal.
